(19) United States
(12) Patent Application Publication
(10) Pub. No.: US 2023/0305873 A1
(43) Pub. Date: Sep. 28, 2023

(54) ANALYTICS PORTAL FOR AIR-GAPPED HYPERCONVERGED INFRASTRUCTURE IN A HYBRID CLOUD ENVIRONMENT

(71) Applicant: VMware, Inc., Palo Alto, CA (US)

(72) Inventors: Yang YANG, Shanghai (CN); Yang YANG, Shanghai (CN); Sixuan YANG, Shanghai (CN); Jin FENG, Shanghai (CN)

(73) Assignee: VMware, Inc., Palo Alto, CA (US)

(21) Appl. No.: 17/704,020

(22) Filed: Mar. 25, 2022

(51) Int. Cl. G06F 9/455

(52) U.S. Cl. CPC G06F 9/45558; G06F 2009/45595

(57) ABSTRACT

An analytics portal, having a machine learning model, is deployed at an edge device in a virtualized computing environment. The machine learning model may be trained internally in the virtualized computing environment or via trained models received via an external network such as a cloud. The analytics portal is in an active mode, while another analytics portal at another host or edge device in the virtualized computing environment is in a passive mode. An election process may be used to change an analytics portal from the active mode to the passive mode. A failover process is also available to transition the passive analytics portal to the active mode, in response to a failure of the current active analytics portal.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

A software-defined approach may be used to create shared storage for VMs and/or for some other types of entities, thereby providing a distributed storage system in a virtualized computing environment. Such software-defined approach virtualizes the local physical storage resources of each of the hosts and turns the storage resources into pools of storage that can be divided and accessed/used by VMs or other types of entities and their applications. The distributed storage system typically involves an arrangement of virtual storage nodes that communicate data with each other and with other devices.

One type of virtualized computing environment that uses a distributed storage system is a hyperconverged infrastructure (HCl) environment, which combines elements of a traditional data center: storage, compute, networking, and management functionality. Capacity planning, prediction, and simulation (which all may be generally considered to be part of capacity planning) are important for an HCl storage environment. Capacity planning may utilize an analytics engine and a data collector. In an example typical hybrid environment, the analytics engine may be located in a cloud (such as a public cloud), and the collector may be located on-premises within a private environment (such as in a private data center or other private network of a customer or other entity). However, the customer's environment is often air-gapped (isolated) from other networks/systems/devices, for purposes of providing the best security for their data center. For example, in an air-gapped arrangement, the computing devices in the customer's environment have no physical or wireless connections with an external network and are therefore prevented from accessing the external network, just as if an air gap exists between the customer's environment and the external network. Correspondingly, computing devices in the external network are also prevented/blocked from communicating with the customer's environment. This air-gapping breaks the assumption that a channel between the data collector and the analytics engine is always robust.

Some HCl environments provide customers with the capability to upload their environment information to a provider's cloud to enable the analytics engine at the cloud to process the environment information using machine learning and to perform other operations using resources of the cloud, such as machine learning model training, health checking, and proactive technical support, etc. This use of the cloud often requires customers to configure their environment with programs like Customer Experience Improvement Program (CEIP) available from VMware, Inc. of Palo Alto, California or other programs that collect the customers' environment information, and further requires the customers to connect their environment to the provider's cloud (an outside network) for purposes of uploading the environment information to the cloud. However, for security considerations, many customers like the government and banks do not allow their environment to be enrolled in the CEIP program or do not allow their environment to have outside network accessibility.

Such isolation of the customer's environment from an outside network, such as via an air-gapped arrangement, poses a number of challenges when capacity planning and/or other processes need to be performed.

### BRIEF DESCRIPTION OF DRAWINGS

FIG. 1 is a schematic diagram illustrating an example virtualized computing environment that can implement an analytics portal in an edge device;

FIG. 2 is a schematic diagram illustrating the workflows of analytics portals deployed at edge devices;

FIG. 3 is a flowchart of an example process to discover and register an analytics portal for deployment in an edge device;

FIG. 4 illustrates a state diagram for analytics portals that transition between an active mode and a passive mode;

FIG. 5 is a diagram illustrating failover configuration and operation for analytics portals; and

FIG. 6 is a flowchart of an example method to implement analytics portals at hosts in the virtualized computing environment of FIGS. 1 and 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be implemented in connection with other embodiments whether or not explicitly described.

The present disclosure addresses various drawbacks, such as described above, associated with using an analytics engine/portal at a cloud for purposes of capacity planning and/or for other purposes, in a hyperconverged infrastructure (HCl) environment wherein air-gapping or other security restrictions limit the communication of data between an internal network (e.g., a customer/user's private environment) and an external network (e.g., a public cloud managed by a provider or other entity). A public or private cloud can be an example of such an external network. The external network can include one or more computing devices and related components, which may be virtualized and/or non-virtualized.

For example and as explained above, in an HCl storage environment, the analytics portals (analytics engines) may be all deployed on the cloud. This approach relies on customers to enroll in programs like CEIP to upload their environment information (such as statistical data) to the cloud for machine learning model training. If the customer's environment does not have access to the analytics portal or cannot enroll in the program due to security considerations, the machine learning model at the cloud cannot be directly tuned with the data from the customers' environment as a result of the isolation created by the air gap.

As another example, some HCl arrangements might deploy the analytics engine (and related machine learning capability) directly at an edge device in the customer's environment. However, this approach results in a draining of resources of the edge device and/or results a competition with the actual workload for the resources of the edge device. For instance, the resources of the edge device may be drained since the machine learning itself needs a lot of computing and storage resources. Further, the machine learning is also likely to share the same resources with the customer's real workload, and thus result in a negative impact on the performance of the customers' workload. Moreover, the dataset to be learned and consumed in a dedicated customer site (e.g., an edge device that is locally configured with the machine learning capability, without leveraging remote cloud resources) is typically limited, and so the local machine learning may provide insufficient feedback.

Accordingly, the embodiments disclosed herein provide a self-contained analytics portal solution for a HCl storage environment, in which the self-contained analytics portal solution may be used in an air-gapped environment. The embodiments provide the analytics portal at an edge device in the internal network (e.g., on-premises at a data center at the customer environment side) with pre-trained machine learning models. A channel for the on-premises analytics portal enables the analytics portal to communicate with an external network (e.g., a cloud or other external arrangement of one or more computing devices), so as to the pull/push of updates to the machine learning model from the external network to the edge device, based on a service agreement between the customers and a service provider for the external network. Furthermore, the embodiments disclosed herein provide a resource scheduling algorithm so as to locate/migrate the analytics portal amongst edge devices inside the data center so as to minimize resource impacts.

Computing Environment

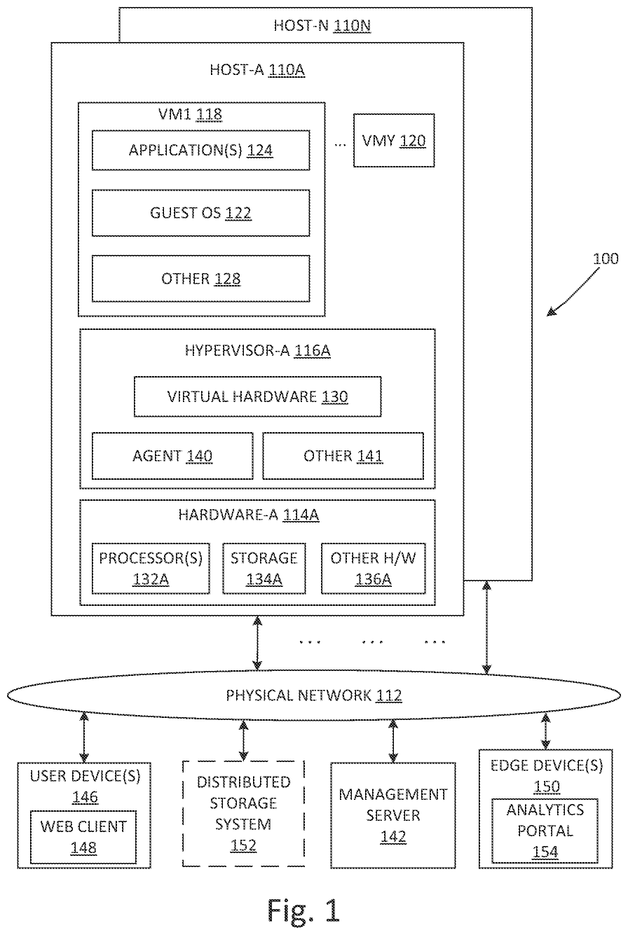

Various implementations will now be explained in more detail using FIG. 1, which is a schematic diagram illustrating an example virtualized computing environment 100 that can implement an analytics portal in an edge device. For instance, an analytics portal 154 may be implemented in one or more edge devices 150, rather than or in addition to being implemented at a cloud (or other external network). Depending on the desired implementation, the virtualized computing environment 100 may include additional and/or alternative components than that shown in FIG. 1. The virtualized computing environment 100 may comprise parts of a data center or other private internal network (e.g., a customer/user environment).

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of host-A 110A. Each of the other hosts can include substantially similar elements and features.

The host-A 110A includes suitable hardware-A 114A and virtualization software (e.g., hypervisor-A 116A) to support various virtual machines (VMs). For example, the host-A 110A supports VM1 118 . . . VMY 120, wherein Y (as well as N) is an integer greater than or equal to 1. In practice, the virtualized computing environment 100 may include any number of hosts (also known as “computing devices”, “host computers”, “host devices”, “physical servers”, “server systems”, “physical machines,” etc.), wherein each host may be supporting tens or hundreds of virtual machines. For the sake of simplicity, the details of only the single VM1 118 are shown and described herein.

VM1 118 may include a guest operating system (OS) 122 and one or more guest applications 124 (and their corresponding processes) that run on top of the guest operating system 122. VM1 118 may include still further other elements 128, such as a virtual disk, agents, engines, modules, and/or other elements usable in connection with operating VM1 118.

The hypervisor-A 116A may be a software layer or component that supports the execution of multiple virtualized computing instances. The hypervisor-A 116A may run on top of a host operating system (not shown) of the host-A 110A or may run directly on hardware-A 114A. The hypervisor-A 116A maintains a mapping between underlying hardware-A 114A and virtual resources (depicted as virtual hardware 130) allocated to VM1 118 and the other VMs. The hypervisor-A 116A of some implementations may include/run one or more monitoring agents 140, which may collect host-level and/or cluster-level information, such as performance metrics indicative of storage capacity/usage, processor load, network performance, or other statistics/data/information pertaining to the customer environment. In some implementations, the agent 140 may reside elsewhere in the host-A 110A (e.g., outside of the hypervisor-A 116A). The agent 140 of various embodiments is configured to provide the collected environment information to the analytics portal 154 residing at the edge device 150 and/or to a management server 142 which in turn provides the information to the analytics portal 154.

The hypervisor-A 116A may include or may operate in cooperation with still further other elements 141 residing at the host-A 110A. Such other elements 141 may include drivers, agent(s), daemons, engines, virtual switches, and other types of modules/units/components that operate to support the functions of the host-A 110A and its VMs, as well as functions associated with using storage resources of the host-A 110A for distributed storage.

Hardware-A 114A includes suitable physical components, such as CPU(s) or processor(s) 132A; storage resources(s) 134A; and other hardware 136A such as memory (e.g., random access memory used by the processors 132A), physical network interface controllers (NICs) to provide network connection, storage controller(s) to access the storage resources(s) 134A, etc. Virtual resources (e.g., the virtual hardware 130) are allocated to each virtual machine to support a guest operating system (OS) and application(s) in the virtual machine, such as the guest OS 122 and the applications 124 in VM1 118. Corresponding to the hardware-A 114A, the virtual hardware 130 may include a virtual CPU, a virtual memory, a virtual disk, a virtual network interface controller (VNIC), etc.

Storage resource(s) 134A may be any suitable physical storage device that is locally housed in or directly attached to host-A 110A, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, integrated drive electronics (IDE) disks, universal serial bus (USB) storage, etc. The corresponding storage controller may be any suitable controller, such as redundant array of independent disks (RAID) controller (e.g., RAID 1 configuration), etc.

A distributed storage system 152 may be connected to each of the host-A 110A . . . host-N 110N that belong to the same cluster of hosts. For example, the physical network 112 may support physical and logical/virtual connections between the host-A 110A . . . host-N 110N, such that their respective local storage resources (such as the storage resource(s) 134A of the host-A 110A and the corresponding storage resource(s) of each of the other hosts) can be aggregated together to form a shared pool of storage in the distributed storage system 152 that is accessible to and shared by each of the host-A 110A . . . host-N 110N, and such that virtual machines supported by these hosts may access the pool of storage to store data. In this manner, the distributed storage system 152 is shown in broken lines in FIG. 1, so as to symbolically convey that the distributed storage system 152 is formed as a virtual/logical arrangement of the physical storage devices (e.g., the storage resource(s) 134A of host-A 110A) located in the host-A 110A . . . host-N 110N. However, in addition to these storage resources, the distributed storage system 152 may also include stand-alone storage devices that may not necessarily be a part of or located in any particular host.

According to some implementations, two or more hosts may form a cluster of hosts that aggregate their respective storage resources to form the distributed storage system 152. The aggregated storage resources in the distributed storage system 152 may in turn be arranged as a plurality of virtual storage nodes. Other ways of clustering/arranging hosts and/or virtual storage nodes are possible in other implementations.

The management server 142 (or other network device configured as a management entity) of one embodiment can take the form of a physical computer or with functionality to manage or otherwise control the operation of host-A 110A . . . host-N 110N, including operations associated with the distributed storage system 152. In some embodiments, the functionality of the management server 142 can be implemented in a virtual appliance, for example in the form of a single-purpose VM that may be run on one of the hosts in a cluster or on a host that is not in the cluster of hosts. The management server 142 may be operable to collect usage data associated with the hosts and VMs, to configure and provision VMs, to activate or shut down VMs, to monitor health conditions and diagnose/troubleshoot and remedy operational issues that pertain to health, and to perform other managerial tasks associated with the operation and use of the various elements in the virtualized computing environment 100 (including managing the operation of and accesses to the distributed storage system 152).

The management server 142 may be a physical computer that provides a management console and other tools that are directly or remotely accessible to a system administrator or other user. The management server 142 may be communicatively coupled to host-A 110A . . . host-N 110N (and hence communicatively coupled to the virtual machines, hypervisors, hardware, distributed storage system 152, etc.) via the physical network 112. In some embodiments, the functionality of the management server 142 may be implemented in any of host-A 110A . . . host-N 110N, instead of being provided as a separate standalone device such as depicted in FIG. 1.

A user may operate a user device 146 to access, via the physical network 112, the functionality of VM1 118 . . . VMY 120 (including operating the applications 124), using a web client 148. The user device 146 can be in the form of a computer, including desktop computers and portable computers (such as laptops and smart phones). In one embodiment, the user may be an end user or other consumer that uses services/components of VMs (e.g., the application 124) and/or the functionality of the distributed storage system 152. The user may also be a system administrator that uses the web client 148 of the user device 146 to remotely communicate with the management server 142 via a management console for purposes of performing management operations.

The edge device 150 of various embodiments can be similarly configured as one of the host-A 110A . . . host-N 110N so as to include VMs, a hypervisor, OS(s), hardware resources, etc., but with additional functionality to facilitate communication between elements within the virtualized computing environment 100 (e.g., VMs, storage nodes, hosts, etc.) and an external network (such as a cloud). For instance, the edge device 150 may include routing tables, firewalls, routers/switches, network address translation (NAT) components, network interface cards (NICs), and other centralized or distributed communication/networking-related hardware and software components to establish and support communications between elements within the virtualized computing environment 100 and the external network (e.g., a cloud).

The analytics portal 154 (deployed in the edge device 150) of various embodiments provides a self-contained service that performs analytics using the environment information provided by the agents 140 of the hosts, including performing analytics using machine learning techniques. Such analytics may be performed, for example, to determine the current capacity of storage resources in the distributed storage system 152 and to determine when (and how much) additional storage should be provisioned (e.g., capacity planning). As will be explained further below, multiple analytics portals 154 can be created amongst multiple edge devices in the virtualized computing environment 100 and used for failover, load distribution, etc.

The edge device 150 may include or may be communicatively coupled to still further components, which may be part of or separate from the analytics portal. For example, such further components can include a database or datastore, election components or other types of components to determine when to initiate a migration of the analytics portal 154 to another edge device and then perform the migration, etc.

Depending on various implementations, one or more of the physical network 112, the management server 142, the edge 154, and the user device(s) 146 can comprise parts of the virtualized computing environment 100, or one or more of these elements can be external to the virtualized computing environment 100 and configured to be communicatively coupled to the virtualized computing environment 100.

Workflows for Analytics Portals Deployed at Edge Devices

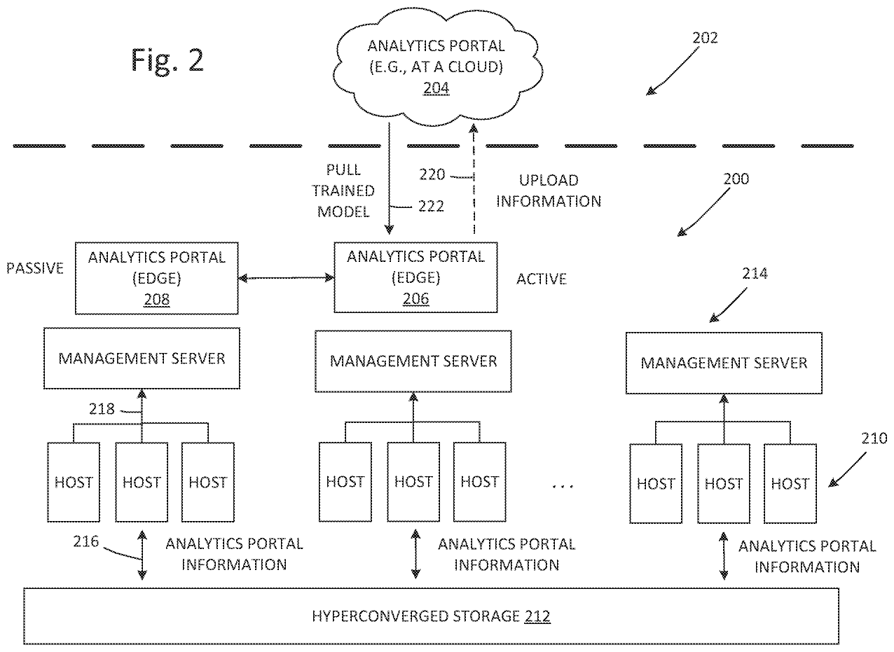

FIG. 2 is a schematic diagram illustrating the workflows of analytics portals deployed at edge devices, such as the edge devices 150 in the virtualized computing environment of FIG. 1. An internal network 200 (e.g., a customer environment) and an external network 200 (e.g., a public cloud environment) are shown. The external network 202 includes an analytics portal 204 deployed at a cloud, for purposes of simplicity of explanation and as examples hereinafter in some of the disclosed embodiments—the analytics portal 204 may be deployed in various types of external network arrangements that include one or more computing devices and which may not necessarily be arranged as a cloud environment.

The internal network 200 includes analytics portals 206 and 208 (analogous to the analytics portal 154 shown in FIG. 1) respectively deployed at edge devices (e.g., the edge device(s) 150 shown in FIG. 1). The analytics portal 206 may be in active mode, while the analytics portal 208 may be in passive mode. The active/passive modes will be described later below.

The internal network 200 further includes a plurality of hosts 210 (e.g., the host-A 110A . . . host-N 110N shown in FIG. 1) that are configured to provide storage resources for a hyperconverged storage 212 (e.g., the distributed storage system 152 shown in FIG. 1). The operation of the hosts 210 is managed by one or more management servers 214 (e.g., the management server 142 shown in FIG. 1).

In operation, the agent 140 (shown in FIG. 1) at each host 214 collects (at 216) customer environment information (e.g., performance metrics, statistics, etc., all of which are labeled as analytics portal information in FIG. 2) from the hyperconverged storage 212. The management server(s) 214 then collects (at 218) this analytics portal information from each of the managed hosts 210, aggregates the information, and sends the aggregated information to the active analytics portal 206 deployed at the edge device.

According to various embodiments, the analytics portals (e.g., the active analytics portal 206) may have three possible modes of operation. In a pass-through mode of operation, the active analytics portal 206 sends (at 220) the collected information directly to the analytics portal 204 at the cloud (or other computing device(s) deployed at the external network 202) for machine learning model training. The analytics portal 204 at the external network 202 in turn generates a trained machine learning model based on at least some of the collected information. The trained machine learning model can then also be pulled (at 222) from the external network 202 and deployed on the edge where the active analytics portal 206 resides. In various embodiments, the trained machine learning model may be duplicated and transmitted to one or more passive analytics portals (e.g., the passive analytics portal 208). In this manner, when a failover or other proactive migration occurs for an active analytics portal, the new active analytics portal will also have the latest obtained/pulled trained machine learning model. The trained machine learning model may be provided to the passive analytics portal(s) by persisting a copy of the trained machine learning model in a model database (DB), described later below, that is shared amongst all of the analytics portals. The pass-through mode may be used when customers/users are able to connect to the cloud service at the external network 202 and are also able to enroll in a CEIP program (or analogous) program that permits the uploading of customer environment information to the external network 202.

As previously explained above, some customer environments do not permit uploading of customer environment information to the external network 204. Thus, such uploading is represented at 220 in broken lines, so as to symbolically indicate that uploading capability is not available for all modes of the analytics portals deployed at edge devices.

For example in a pull-only mode of operation, no customer environment information (e.g., analytics portal information) is uploaded (at 220) to the analytics portal 204 at the external network 202 via the analytics portal 206 deployed at the edge device. In this pull-only mode of operation, the analytics portal 206 only pulls (at 222) a machine learning model from the cloud, so as to update a local machine learning model that is deployed by the analytics portal 206 at the edge device, and blocks the customer environment information from being sent to the external network 202. The analytics portal 206 also uses the locally collected customer environment information to fine-tune the local machine learning model. This pull-only mode of operation can be used in situations (e.g., based on user agreements or organization policies) wherein users are able to connect to a cloud service at the external network 202 (e.g., for purposes of obtaining a machine learning model from the cloud), but the users are not permitted to upload information from their environment to the external network 202 (e.g., no participation in a CEIP program or analogous program).

According to an offline mode of operation, analytics portal 206 at the edge device is pre-deployed with a machine learning model at the product release time. No local machine learning model is refreshed/updated from the external network 202, and no information is uploaded to external network 202 as well. In this offline mode of operation, the analytics portal 206 uses the local collected customer environment information to fine-tune the pre-deployed machine learning model. This offline mode of operation can be used when users' environments are fully air gapped, in that there is no cloud service access and there is no enrollment in a CEIP program (or analogous program).

Analytics Portal Discovery/Registration

According to some embodiments, an image of an analytics portal (to be deployed at an edge device) may be built with VM/container templates and can be run in a VM or container. The image for the analytics portal is written to a hyperconverged storage, such as one or more remote datastores or databases (DBs) in the hyperconverged storage 212 of FIG. 2.

The data stored on the hyperconverged storage may contain the following example entries of Table 1:

TABLE 1

| Name | Type | Purpose |
|---|---|---|
| Portal Image | VM/container | Used to deploy the VM/container |
| | image or template | for the analytics portal |
| Configuration | Lightweight DB | Used to store the configuration |
| DB | | data for the analytics portal, |
| | | including the failover portal IP, |
| | | analytics portal's populated |
| | | hosts, etc. |
| Training Record | DB | Used to store the machine learning |
| DB | | model's training records. |
| Model DB | DB | Used to store the trained model |

In accordance with Table 1 above, the image of the analytics portal may be stored as a VM or container image/template, and may be downloaded for installation into an edge device. A configuration DB (such as a lightweight DB) may store the configuration data for the analytics portal, including the failover portal IP address, the analytics portal's populated hosts, etc. A training record DB may store the training records for the machine learning model used by the analytics portal, and a model DB may be used to store the trained machine learning model.

The analytics portal of some embodiments is designed to run stateless inside the VM or container. For instance, the analytics portal does not persist any data within the VM/container itself, and instead, the data for the analytics portal is stored directly in the configuration DB, training record DB, or the model DB persisted on the remote hyperconverged storage described above. This arrangement provides flexibility for the analytics portal's failover/migration (described in further detail below). For example, once a primary analytics portal is done (e.g., no longer active), a secondary analytics portal can easily pick up all of the running context from the persisted data in the remote hyperconverged storage and continue the analytics service.

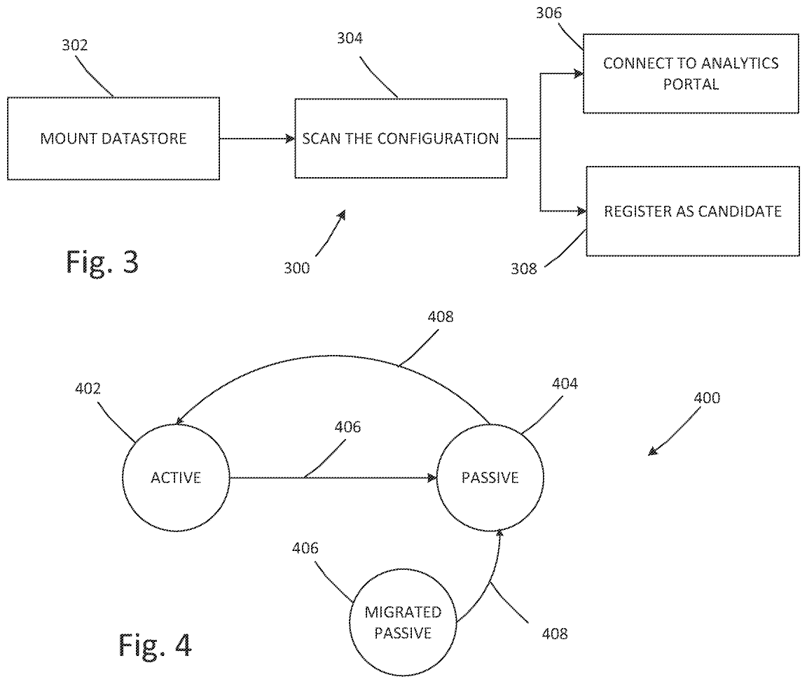

FIG. 3 is a flowchart of an example process 300 to discover and register an analytics portal for deployment in an edge device. For instance, the process 300 may be a workflow/method implemented in the internal network 200 of FIG. 2. A management server (e.g., the management server 214) or some other network device may perform at least some of the operations of the process 300.

The example process 300 may include one or more operations, functions, or actions illustrated by one or more blocks, such as blocks 302 to 308. The various blocks of the process 300 and/or of any other process(es) described herein may be combined into fewer blocks, divided into additional blocks, supplemented with further blocks, and/or eliminated based upon the desired implementation. In one embodiment, the operations of the process 300 and/or of any other process(es) described herein may be performed in a pipelined sequential manner. In other embodiments, some operations may be performed out-of-order, in parallel, etc.

For each cluster of hosts 210, the management server 214 can mount the datastore to register to the analytics portal service, at a block 302 (“MOUNT DATASTORE”). Once the datastore is mounted, the management center 214 for this cluster of hosts scans the configuration DB on the datastore, at a block 304 (“SCAN THE CONFIGURATION”), so as to discover the configuration information for the analytics portal. From the configuration information, the management server 214 can obtain all of the analytics portals, including both active and passive (standby) analytics portals, and respectively deploy the analytics portals at the edge devices.

The management server 214 then starts to collect environment information (e.g., performance metrics and other statistics/data from the hosts 210), and sends the collected information to the active analytics portal (e.g., the active analytics portal 206 in FIG. 2), at a block 306 (“CONNECT TO ANALYTICS PORTAL”). In various embodiments, the obtained information for the analytics portal(s) from the block 304 may be used by the management server 214 and/or by other devices to access the currently active analytics portal—since the active analytics portal may migrate from one host (edge device) to another based on workload or failover status, the information for the active analytics portal may thus change from time to time, and such information may be used to connect to a currently active analytics portal. In the meantime at the block 306, the management server 214 also registers the host(s) in the cluster as a portal placement candidate, at a block 308 (“REGISTER AS CANDIDATE”), such as for purposes of migration of analytics portals to and within a cluster of hosts 210. The migration of analytics portals to/within a cluster of hosts may be based on a migration algorithm, which is described later below with respect to FIG. 4.

Auto-Migration of Analytics Portals

An analytics portal deployed on an edge device will need to train its machine learning model with the data collected from the customer environment, and so the analytics portal would consume a large amount of resources on the host (edge device), such as the CPU and/or graphical processing unit (GPU) resources. However, in the hyperconverged environment, the CPU/GPU resources consumed by the analytics portal are shared with the customer's workload (e.g., the business workload or other normal workload) on the edge device. Thus, both the analytics workload and customer's workload can interfere with each other. To minimize or otherwise reduce the impact of deploying an analytics portal at an edge device, various embodiments provide an auto-migration method/algorithm for the analytics portals.

In some embodiments, the vSAN HCl mesh feature (available from VMware, Inc. of Palo Alto, California) can be leveraged for the auto-migration. With the vSAN HCl mesh feature (or with other analogous platforms), vSAN storage clusters can be shared to any computing cluster (e.g., hosts) in the HCl environment. Accordingly, an analytics portal deployed on a particular host (e.g., edge device) is capable of accessing/processing the customer environment information across one or multiple storage clusters for purposes of performing analytics. An algorithm may be performed below (e.g., by a management server) to determine the destination (edge device) for placing the analytics portal, and then to perform, when appropriate, a failover of the VM(s) (running the analytics portal) to another host (edge device) which has more free/suitable computing resource.

According to some implementations, there are two analytics portals deployed across the cluster, such as the analytics portal 206 and the analytics portal 208 in FIG. 2. One of the analytics portals (e.g., the analytics portal 206) is working in the active mode, and can accept the customer environment information (such as statistics data) from each cluster and perform the machine learning model training and other analytics operations. The other analytics portal (e.g., the analytics portal 208) is working in the passive mode, in which the edge device is performing its normal workload and the analytics portal 208 is performing minimal or no analytics operations.

FIG. 4 illustrates a state diagram 400 for analytics portals that transform between an active mode 402 and a passive mode 404. An election method is performed to determine which of the two or more edge devices will run an analytics portal in the active mode 402 (and the other edge device(s) will in turn run in the passive mode 404). According to various embodiments, the determination of both active and passive mode analytics portals is based on a comparison between the free/available resources on their respective hosts (edge devices). A score may be computed, for example by a management server 214 or other entity that acts as an arbitrator/decision-maker), according to the following example formula:

score=αCPU+βMemory+γGPU

In the above formula, CPU, Memory, and GPU are values corresponding to the processor/memory capacity of the edge device, which are then multiplied by respective α, β, and γ weights that can be customized based on the analytics portal's analytics tasks/workloads. Summing these values results in the score. The edge device with the higher/highest score wins the election and become the active analytics portal.

The computation of the score may be subsequently repeated over time, such as at subsequent and sequential timeslots, since the workloads (both normal workload and analytics workload) may change. Once the currently active analytics portal loses the election (e.g., has a lower score than a currently passive analytics portal, due to approaching or reaching its resource limit), the active analytics portal is downgraded (at 406) from the active mode 402 to the passive mode 404. The passive analytics portal (which has won the election due to now having a higher score corresponding to sufficient resources) transitions (at 408) from the passive mode 404 to the active mode 402 in a next time slot.

According to some embodiments, a migrated passive mode 406 is provided to encompass the migration of the passive mode for an analytics portal. For example, a new host (edge device) may join the cluster or an existing host in the cluster may acquire further resources (such as via an upgrade, reduction in existing workload, etc.). Thus for the cluster, there may be a particular host that now has more free resources than either or both of the edge devices that are hosting active and passive analytics portals. In such a situation, the particular host will have a score that is higher than either or both of the host that is hosting the active analytics portal and the host that is hosting the passive analytics portal.

Such particular host launches/creates a passive analytics portal, which initially will be in the migrated passive mode 406. Once this analytics portal (in the migrated passive mode 406) is all prepared (e.g., its configuration has been completed to enable performance of analytics operations), this analytics portal will claim (at 408) the role of being the analytics portal in the passive mode 404. Then, the current passive analytics portal (which had a lower score) is torn down or otherwise deactivated. After one or more subsequent timeslots ∂, if the newly launched passive analytics portal still wins the election by virtue of having a higher score than the others, then this analytics portal will assume the role of being the active analytics portal to replace the current active analytics portal.

In some embodiments, only the host (edge device) that keeps winning the score for more than (∂+1) timeslots will be used to replace the current active analytics portal with the newly created analytics portal. This avoids frequent changes in active analytics portals. Moreover, only a passive analytics portal can be converted to active analytics portal—there is no direct conversion from the migrated passive mode 406 to the active mode 402. This restriction makes the transition between modes more reliable since the migrated passive analytics portal is provided with more time to be prepared/configured to perform analytics operations.

From the state diagram 400 of FIG. 4 and the foregoing description of the auto-migration process, it can thus be seen that the active analytics portal is migrated to the host (edge device) which has more free resources relative to other hosts. This migration process avoids or otherwise reduces the interference between the workload of both the analytics portal and the user's normal workload.

Analytics Portal Failover

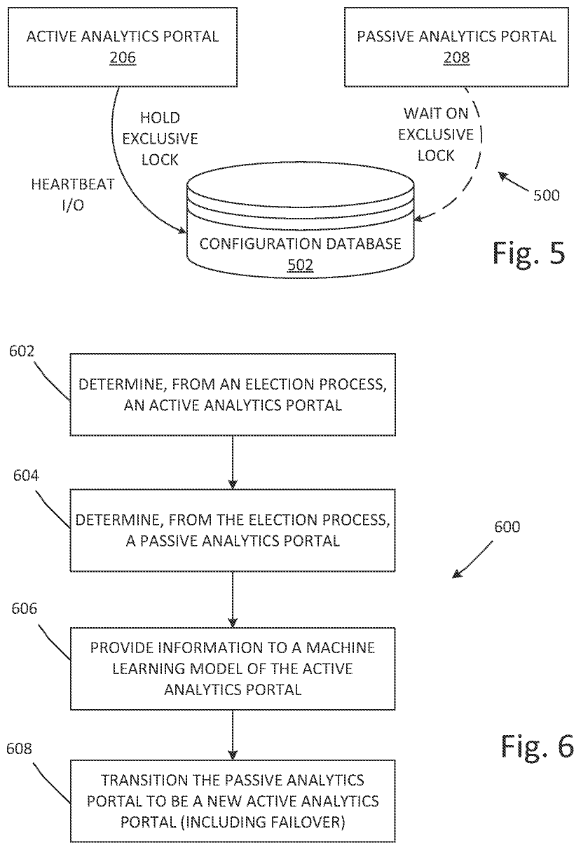

FIG. 5 is a diagram 500 illustrating failover configuration and operation for analytics portals. According to various embodiments the active analytics portal 206 holds an exclusive lock to the active portal entry within a configuration DB 502. The detection of the liveness of the exclusive lock is done through the heartbeat input/output (I/O) signal sent by the active analytics portal 206 to the datastore.

For instance, the active analytics portal 206 sends heartbeat I/O signals to the configuration DB 502 on the datastore. If the heartbeat I/O signals timeout (e.g., are not timely received), then the configuration DB 502 or the management server 214 marks the analytics portal 206 as having lost its liveness. The management server 214 thus releases the exclusive lock to the active portal entry in the configuration DB 502.

Meanwhile, the passive analytics portal 208, which has been waiting on acquiring the exclusive lock to the same active portal entry in the configuration DB 502, acquires the exclusive lock after the active analytics portal's 206 heartbeat has timed out. This passive analytics portal 208 then becomes the new active analytics portal.

The previously active analytics portal may come back to life later, but has already lost the exclusive lock by that time. As such, this analytics portal marks itself or is marked by the management server 214 as a passive analytics portal, and may participate/register as a candidate to be an active analytics portal, such as by using the election process previously described above with respect to FIG. 4.

Having thus described the failover process above, FIG. 6 is a flowchart of an example method 600 to implement analytics portals at hosts in the virtualized computing environment of FIGS. 1 and 2, with the method 600 depicting the election process, the machine learning for performing analytics services, and the failover process. The management server 214 or other network device or entity may perform at least some of the operations in the method 600 in some embodiments.

The method 600 may begin at a block 602 (“DETERMINE, FROM AN ELECTION PROCESS, AN ACTIVE ANALYTICS PORTAL”), wherein the management server uses the election process (described above with respect to FIG. 4) to determine which of the hosts (edge devices) has the highest score corresponding to the largest amount of available resources. The host with the highest score is chosen as the host where the active analytics portal will be deployed.

At a block 604 (“DETERMINE, FROM THE ELECTION PROCESS, A PASSIVE ANALYTICS PORTAL”), wherein the host with a lower score (such as the next lower score from the highest score) is chosen as the host where the passive analytics portal will be deployed.

The blocks 602 and 604 may be followed by a block 606 (“PROVIDE INFORMATION TO A MACHINE LEARNING MODEL OF THE ACTIVE ANALYTICS PORTAL”), wherein the management server 214 aggregates the customer environment information collected by the hosts, and provides this information to the machine learning model of the active analytics portal. The machine learning model may in turn consume this information in order to provide output for use in a capacity planning purposes and/or for other purposes.

The block 606 may be followed by a block 608 (“TRANSITION THE PASSIVE ANALYTICS PORTAL TO BE A NEW ACTIVE ANALYTICS PORTAL (INCLUDING FAILOVER)”), wherein the management server 214 continues to conduct elections at timeslots in order to determine if the active analytics portal no longer has the highest score. If no longer the highest score, then the passive analytics portal is transitioned to be the new active analytics portal. The previous active analytics portal transitions to be a passive analytics portal or is deactivated.

Also at the block 608, operations to generate and transition a migrated passive analytics portal, into a passive analytics portal and then possibly thereafter into an active analytics portal, may be performed. Further at the block 608, a passive analytics portal may transition to be the new active analytics portal, in a failover scenario wherein the active analytics portal fails to timely provide heartbeat I/O signals.

From the foregoing description, a number of benefits are provided by deploying an analytics portal at an edge device. For example, capability is provided for training a machine learning model and for performing other analytics services (which are otherwise typically performed at a cloud or other arrangement of one or more computing devices in an external network) using information from an air-gapped internal network. Furthermore, the disclosed embodiments consolidate the cloud users, on-premises CEIP-enrolled users, and air-gapped cases with all-in-one approach.

As another example, analytics portal deployed at the edge devices can migrate intelligently across the customer's/user's environment to find a best fit host for providing the analytics service, while maintaining the stability of the analytics service in a hyperconverged environment. Thus, the analytics portal can be a better fit in the hyperconverged storage environment and can provides intelligent analytics features with high availability and less interference with users' workloads.

As still another example, a scheduling algorithm and workflow deploy the analytics portal at the edge device, with updated/trained models being made available from the external network such as a cloud. This approach can be built into the existing systems/networks so as to orchestrate and manage the lifecycle of the analytics portal.

Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1 to 6.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment and/or a distributed storage system), wherein it would be beneficial to provide improved deployment of analytics portals for capacity planning and other operations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other computer-readable instruction to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

We claim:

1. A method to implement analytics portals at hosts in a virtualized computing environment, the method comprising:
determining, from an election process, an active analytics portal to deploy at a first host;
determining, from the election process, a passive analytics portal to deploy at a second host;
provide information collected from the virtualized computing environment to a machine learning model of the active analytics portal for use in capacity planning; and
in response to determining that the second host has a greater number of available resources than the first host, transitioning the passive analytics portal to be a new active analytics portal deployed at the second host in place of the active analytics portal deployed at the first host.

2. The method of claim 1, wherein the first and second hosts are edge devices in the virtualized computing environment.

3. The method of claim 1, wherein determining the active and passive analytics portals from the election process comprises:
determining a first score of the first host based on available resources of the first host;
determining a second score of the second host based on available resources of the second host;
identifying the first host for deployment of the active analytics portal therein, in response to the first score being higher than the second score.

4. The method of claim 1, wherein the active analytics portal deployed at the first host operates in a pass-through mode, and wherein in the pass-through mode:
the information collected from the virtualized computing environment is sent to an analytics portal deployed at an external network outside of the virtualized computing environment,
the analytics portal deployed at the external network uses the collected information to generate a trained machine learning model, and
the active analytics portal receives the trained machine learning model from the external network, and the trained machine learning model is duplicated in the passive analytics portal from a persisted copy of the trained machine learning model in a shared database.

5. The method of claim 1, wherein the active analytics portal deployed at the first host operates in a pull-only mode, and wherein in the pull-only mode:
the first host blocks the information collected from the virtualized computing environment from being sent to an analytics portal deployed at an external network outside of the virtualized computing environment,
the active analytics portal deployed at the first host obtains the machine learning model from the external network, and
the active analytics portal deployed at the first host uses the information collected from the virtualized computing environment to tune the machine learning model.

6. The method of claim 1, wherein the active analytics portal deployed at the first host operates in an offline mode, and wherein in the offline mode:
the machine learning model is pre-deployed at the first analytics portal,
the first host blocks the information collected from the virtualized computing environment from being sent to an analytics portal deployed at an external network outside of the virtualized computing environment, and
the active analytics portal deployed at the first host uses the information collected from the virtualized computing environment to tune the pre-deployed machine learning model, rather than refreshing the machine learning model with a trained machine learning model from the analytics portal deployed at the external network.

7. The method of claim 1, wherein transitioning the passive analytics portal to be the new active analytics portal is performed in response to a failover condition in which the active analytics portal has failed to timely send heartbeat signals.

8. The method of claim 1, further comprising:
launching an analytics portal at a third host;
in response to the third host having a greater number of available resources than the second host, transitioning the analytics portal at the third host to be a new passive analytics portal deployed at the third host, and deactivating the passive analytics portal deployed at the second host; and
after deactivation of the passive analytics portal deployed at the second host and in response to the third host having a greater number of available resources than the first host, transitioning the passive analytics portal deployed at the third host to be a new active analytics portal deployed at the third host to replace the active analytics portal deployed at the first host.

9. A non-transitory computer-readable medium having instructions stored thereon, which in response to execution by one or more processors, cause the one or more processors to perform or control performance of a method to implement analytics portals at a plurality of hosts in a virtualized computing environment, wherein the method comprises:
operating an active analytics portal at a first host of the plurality of hosts, wherein the active analytics portal includes a machine learning model configured to use information collected from the virtualized computing environment to perform analytics services;
monitoring resource availability at the plurality of hosts so that a host having a highest amount of available resources is selected for deployment of the active analytics portal;
in response to determination that the first host has fewer available resources than a second host of the plurality of hosts, transitioning a passive analytics portal deployed at the second host to be a new active analytics portal deployed at the second host; and
transitioning the analytics portal deployed at the first host from active to passive.

10. The non-transitory computer-readable medium of claim 9, wherein monitoring the resource availability at the hosts comprises performing an election process at timeslots to compute a score for each of the hosts, wherein the score is indicative of the resource availability at each host, and wherein values of the resource availability at each host are weighted in the computation of the score.

11. The non-transitory computer-readable medium of claim 9, wherein the active analytics portal has, while active, an exclusive lock on an active portal entry in a configuration database.

12. The non-transitory computer-readable medium of claim 11, wherein in response to a failure of the active analytics portal, the exclusive lock on the active portal entry is released to enable the passive analytics portal to acquire the exclusive lock on the active portal entry.

13. The non-transitory computer-readable medium of claim 9, wherein the method further comprises:
launching an analytics portal at a third host of the plurality of hosts,
in response to the third host having a greater number of available resources than the second host, transitioning the analytics portal at the third host to be a new passive analytics portal deployed at the third host, and deactivating the passive analytics portal deployed at the second host; and
after deactivation of the passive analytics portal deployed at the second host and in response to the third host having a greater number of available resources than the first host, transitioning the passive analytics portal deployed at the third host to be a new active analytics portal deployed at the third host to replace the active analytics portal deployed at the first host.

14. The non-transitory computer-readable medium of claim 9, wherein the first and second hosts are edge devices, and wherein an air gap arrangement restricts communication between the active analytics portal deployed at the first host and an analytics portal deployed at an external network outside of the virtualized computing environment.

15. A host in a virtualized computing environment, the host comprising:
one or more processors; and
a non-transitory computer-readable medium coupled to the one or more processors and having instructions stored thereon which, in response to execution by the one or more processors, cause the one or more processors to perform or control performance of operations that include:
launching an active analytics portal deployed at the host, wherein the analytics portal includes a machine learning model;
receiving information collected from the virtualized computing environment, and operate the machine learning model to use the received information to perform analytics;
obtaining updates to the machine learning model that are based on at least some of the collected information; and
transitioning from the active analytics portal to a passive analytics portal deployed at the host, in response to resource availability at the host being less than resource availability at another host.

16. The host of claim 15, wherein the operations to obtain the updates to the machine learning model includes one of:
obtaining a trained machine learning model from an analytics portal deployed at an external network outside of the virtualized computing environment, wherein the analytics portal deployed at the external network uses at least some of the collected information to generate the trained machine learning model; or
obtaining the machine learning from the analytics portal deployed at the external network outside of the virtualized computing environment, wherein the active analytics portal deployed at the host uses at least some of the collected information to tune the machine learning model; or
using at least some of the information collected from the virtualized computing environment to tune the machine learning model, without any communication to and from the analytics portal deployed at the external network.

17. The host of claim 15, wherein the operations further include:
asserting an exclusive lock on an active portal entry in a configuration database; and
sending heartbeat signals to the configuration database while the exclusive lock is asserted by the active analytics portal, wherein the exclusive lock by the active analytics portal is released in response to a failure to timely send the heartbeat signals and is acquired by the passive analytics portal.

18. The host of claim 15, wherein the host is configured as an edge device.

19. The host of claim 15, wherein:
the host is a first host and the another host is a second host,
a third host in the virtualized computing environment has a greater number of available resources than either or both the first and second hosts,
in response to the third host having a greater number of available resources than the second host, an analytics portal deployed at the third host becomes a new passive analytics portal to replace a passive analytics portal deployed the second host, and
in response to the third host having a greater number of available resources than the first host, the passive analytics portal deployed at the third host becomes a new active analytics portal to replace the active analytics portal deployed the first host.

20. The host of claim 15, wherein the machine learning model is configured to use the received information to perform analytics for capacity planning.
